(19) United States
(12) Patent Application Publication
(10) Pub. No.: US 2008/0168321 A1
(43) Pub. Date: Jul. 10, 2008

(54) METHOD AND APPARATUS FOR TRANSMITTING REVERSE ACK/NACK FOR FORWARD CONTROL CHANNEL IN MOBILE COMMUNICATION SYSTEM SUPPORTING HARQ

(75) Inventors: Yeon-Ju Lim, Seoul (KR); Hwan-Joon Kwon, Suwon-si (KR); Jae-Chon Yu, Suwon-si (KR); Dong-Hee Kim, Yongin-si (KR); Jin-Kyu Han, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/966,469

(22) Filed: Dec. 28, 2007

(30) Foreign Application Priority Data
Dec. 29, 2006 (KR) 139057/2006

(51) Int. Cl. H04L 1/08; G06F 11/14

(52) U.S. Cl. 714/748

(57) ABSTRACT

A method and apparatus for transmitting a reverse ACK/NACK for a forward control channel in a mobile communication system supporting HARQ are provided. Control information is received for decoding a packet from a base station over the forward control channel. The packet from the base station is received in an HARQ scheme over a forward data channel. An ACK/NACK for the control information is transmitted to the base station over a first reverse ACK channel, when an mth sub-packet corresponding to each retransmission of the packet is received from the base station. Here, m is a predetermined integer greater than or equal to two.

### PRIORITY

This application claims priority under 35 U.S.C. § 119(a) to an application entitled “Method and Apparatus for Transmitting Reverse ACK/NACK for Forward Control Channel in Mobile Communication System Supporting HARQ” filed in the Korean Intellectual Property Office on Dec. 29, 2006, and assigned Serial No. 2006-0139057, the contents of which are incorporated herein by reference.

### BACKGROUND OF THE INVENTION

1. Field of the Invention

The present invention relates generally to an Orthogonal Frequency Division Multiple Access (OFDMA) mobile communication system, and more particularly, to a method and apparatus for transmitting a decoding a result of control information received over a forward control channel, that is, an Acknowledgement (ACK)/Non-Acknowledgement (NACK), over a reverse control channel in an OFDMA mobile communication system supporting Hybrid Automatic Repeat reQuest (HARQ).

2. Description of the Related Art

In mobile communication systems, active research on an OFDM scheme has recently been conducted for high-speed data transmission over a wired/wireless channel. The OFDM scheme is a data transmission scheme using a multi-carrier, and is also a type of a Multi-Carrier Modulation (MCM) scheme in which a serially input symbol stream is converted into parallel signals, and the respective converted signals are modulated with a plurality of mutually orthogonal sub-carriers and then transmitted.

In the late 1950's, a system employing such a MCM scheme was applied to military communication for the first time, and the OFDM scheme in which a plurality of mutually orthogonal sub-carriers overlap in frequency was developed from the 1970's. However, its actual use in systems was limited because it was very difficult to implement orthogonal modulation between multi-carriers. Rapid progress in the development of OFDM technology has been made since Weinstein et al. reported in 1971 that the OFDM scheme can be efficiently processed using Discrete Fourier Transform (DFT) as OFDM modulation/demodulation. Also, since a scheme in which guard intervals are used and Cyclic Prefix (CP) symbols are inserted into the guard intervals has been disclosed in the art, the negative effects of multi-path propagation and delay spread on systems have been remarkably reduced.

Owing to these technical advances, the OFDM technology is being widely applied to digital transmission technology, such as digital audio broadcasting, digital video broadcasting, a wireless local area network, and a wireless asynchronous transfer mode. That is, the OFDM technology has not been widely used because of its hardware complexity, but has recently become practicable due to the development of various digital signal processing techniques including Fast Fourier Transform (FFT) and Inverse Fast Fourier Transform (IFFT). Although the OFDM scheme is similar to a conventional Frequency Division Multiplexing (FDM) scheme, it is particularly characterized in that it can achieve optimal transmission efficiency at high-speed data transmission by transmitting data while maintaining orthogonality between a plurality of sub-carriers. It is also characterized in that since it has good frequency use efficiency and is robust to multi-path fading, it can efficiently implement optimal high-speed data transmission.

The OFDM scheme also has other advantages in that it is efficient in frequency use due to the use of an overlapped frequency spectrum, it is robust to frequency selective fading and multi-path fading, it can reduce the effect of Inter Symbol Interference (ISI) by using guard intervals, and makes it possible to simply design an equalizer structure in hardware. Moreover, the OFDM scheme is robust to impulsive noises, so that it can be actively used in communication system architectures.

HARQ is one of the important techniques used for improving data throughput and reliability of data transmission in a packet-based mobile communication system. The HARQ technique corresponds to a combination of Automatic Repeat Request (ARQ) and Forward Error Correction (FEC).

The ARQ technique, which is widely used in a wired/wireless data communication system, refers to a technique in which a transmitter transmits data packets with serial numbers attached thereto according to a prearranged scheme, and a receiver requests the transmitter to retransmit a packet with a missing number among the received packets by using the serial numbers, thereby achieving reliable data transmission.

The FEC technique refers to a technique in which transmission data is transmitted together with a redundant bit added thereto according to a predetermined rule, such as convolutional coding or turbo coding, so that the originally transmitted data can be decoded without errors, which may occur in a noise or fading environment during the data transmission/reception.

In a system using the HARQ technique, which is a combination of the above-mentioned ARQ and FEC techniques, a data receiver performs a Cyclic Redundancy Check (CRC) for data received and decoded through a predetermined inverse FEC process to thereby determine if the data is erroneous. As a result of the CRC, when the data has no error, the data receiver feeds back an ACK to a data transmitter so that the data transmitter transmits a next data packet. Contrarily, when the CRC check shows that the data is erroneous, the data receiver feeds back an NACK to the data transmitter so that the data transmitter retransmits the previously transmitted data packet.

FIG. 1 illustrates an example of a common HARQ operation.

In FIG. 1, the abscissa axis represents time, reference numeral 101 denotes initial transmission, and a data channel refers to a channel over which data is actually transmitted. Upon receiving data over the data channel at the initial transmission 101, a data receiver attempts to decode the data. In this process, when the data receiver determines through a CRC that the data received over the data channel has not been successfully decoded, it feeds back an NACK 102 to a data transmitter. Upon receiving the NACK 102, the data transmitter performs retransmission for the data transmitted at the initial transmission 101 (first retransmission 103). Therefore, the data channel carries the same information at the initial transmission 101 and the first retransmission 103. However, it should be noted that although the same information is carried by the data channel, the data transmitted at the initial transmission 101 and the first retransmission 103 may have different redundancies. As used herein, each data transmission in which the same information is carried by the data channel, that is, each transmission designated by reference numeral 101, 103 or 105, is called a sub-packet.

Upon receiving the data retransmitted at the first retransmission 103, the data receiver combines the data of the first retransmission 103 with the data of the initial transmission 101 according to a predetermined rule, and then attempts to decode the data received over the data channel by using a result of the combining. In the process of decoding the data, when the data receiver determines through a CRC for the decoded data that the transmitted data has not been successfully decoded, it feeds back an NACK 104 to the data transmitter.

Upon receiving the NACK 104, the data transmitter performs second retransmission 105 for the data after a predefined time interval passes from the time point of the first retransmission 103.

As a result, the data channel carries the same information at the initial transmission 101, the first retransmission 103, and the second retransmission 105. Upon receiving the data retransmitted at the second retransmission 105, the data receiver combines all the data of the initial transmission 101, the first retransmission 103, and the second retransmission 105 with each other according to the predetermined rule, and then decodes the data received over the data channel using a result of the combining. In this process, when the data receiver determines through a CRC for the decoded data that the transmitted data has been successfully decoded, the data receiver feeds back an ACK 106 to the data transmitter. Upon receiving the ACK 106, the data transmitter transmits an initial transmission sub-packet 107 for next data information. The initial transmission 107 may be performed either as soon as the ACK 106 is received or after a certain time interval passes, which is determined by a predetermined scheduling scheme.

In order to support the HARQ operation as described above, the data receiver must feed back an ACK/NACK to the data transmitter. A channel transmitting the ACK/NACK is called an ACK Channel (ACKCH).

### SUMMARY OF THE INVENTION

The present invention has been made to address at least the above problems and/or disadvantages and to provide at least the advantages described below. Accordingly, an aspect of the present invention provides a method and an apparatus for adjusting a time point of transmission of an ACK/NACK to a base station over a Reverse-link shared control channel ACK Channel (R-scchACKCH) when a mobile station transmits the ACK/NACK regarding whether or not it succeeded in decoding control information received over a Forward-link Shared Control Channel (F-SCCH) to the base station over the R-scchACKCH in an OFDMA mobile communication system.

According to one aspect of the present invention, a method of transmitting a reverse ACK/NACK for a forward control channel in a mobile communication system supporting HARQ is provided. Control information is received for decoding a packet from a base station over the forward control channel. The packet is received from the base station in an HARQ scheme over a forward data channel. An ACK/NACK for the control information is transmitted to the base station over a first reverse ACK channel, when an mth sub-packet corresponding to each retransmission of the packet is received from the base station, wherein m is a predetermined integer of 2 or greater.

According to another aspect of the present invention, a mobile station apparatus is provided for transmitting a reverse ACK/NACK for control information in a mobile communication system supporting HARQ. The apparatus includes a control unit for determining to transmit the ACK/NACK for the control information when the control information for decoding a packet is received from a base station over a forward control channel. The packet is received from the base station in an HARQ scheme over a forward data channel, and then an mth sub-packet corresponding to each retransmission of the packet is received from the base station. The apparatus also includes a transmitter module for transmitting the ACK/NACK for the control information to the base station over a first reverse ACK channel at a time point determined by the control unit.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating a flow of a common HARQ operation;

FIG. 2 is a block diagram illustrating a structure of a mobile station transmitter for transmitting a reverse ACK/NACK in response to forward received data in an OFDMA mobile communication system, according to an embodiment of the present invention;

FIG. 3 is a signal flow diagram of F-SCCH, F-DCH and R-ACKCH transmissions that are performed between a base station and a mobile station when the base station cannot know whether or not the mobile station successfully decodes control information transmitted over a control channel in an OFDM mobile communication system, according to an embodiment of the present invention;

FIG. 4 is a signal flow diagram of F-SCCH, F-DCH, R-scchACKCH and R-ACKCH transmissions that are performed between a base station and a mobile station when the mobile station fails in decoding a first sub-packet and the base station can know whether or not the mobile station successfully decodes control information in an OFDM mobile communication system, according to an embodiment of the present invention;

FIG. 5 is a signal flow diagram of F-SCCH, F-DCH, R-scchACKCH and R-ACKCH transmissions that are performed between a base station and a mobile station when the mobile station succeeds in decoding a first sub-packet and the base station can know whether or not the mobile station successfully decodes control information in an OFDM mobile communication system, according to an embodiment of the present invention;

FIG. 6 is a signal flow diagram of F-SCCH, F-DCH, R-scchACKCH and R-ACKCH transmissions that are performed between a base station and a mobile station, based on a method of determining a time point of ACK/NACK transmission over the R-scchACKCH when the base station can know whether or not the mobile station successfully decodes control information in an OFDM mobile communication system, according to an embodiment of the present invention;

FIG. 7 is a flowchart illustrating an operation of a mobile station for transmitting an ACK/NACK over the R-scchACKCH according to an embodiment of the present invention; and

FIG. 8 is a block diagram illustrating a structure of a mobile station transmitter according to an embodiment of the present invention.

### DETAILED DESCRIPTION OF THE PREFERRED EMBODIMENTS

Preferred embodiments of the present invention are described with reference to the accompanying drawings. It should be noted that similar components are designated by similar reference numerals although they are illustrated in different drawings. Detailed descriptions of constructions or processes known in the art may be omitted to avoid obscuring the present invention.

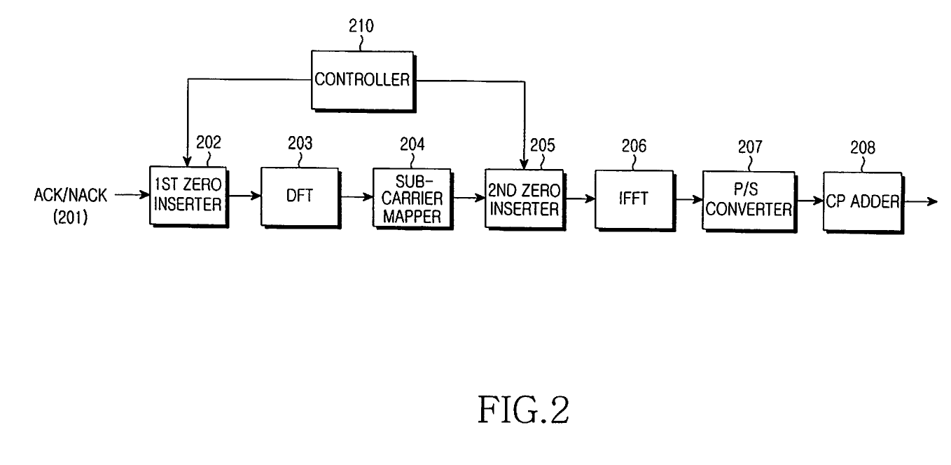

FIG. 2 illustrates the structure of a Mobile Station (MS) transmitter for transmitting a reverse ACK/NACK in response to forward received data in an OFDMA mobile communication system, according to an embodiment of the present invention.

Referring to FIG. 2, the transmitter includes a first zero inserter 202, a 16 point DFT unit 203, a sub-carrier mapper 204, a second zero inserter 205, an IFFT unit 206, a Parallel-to-Serial (P/S) converter 207, a CP adder 208, and a controller 210.

In FIG. 2, reference numeral 201 designates a reverse ACK/NACK bit transmitted by the MS. The value of the ACK/NACK bit is determined according to whether the forward data received by the MS has been successfully decoded or has not been successfully decoded and retransmission thereof is required. The ACK/NACK bit 201 is input to the 16 point DFT unit 203. From among inputs of the DFT unit 203, the MS uses only an input positioned corresponding to a resource channel over which the MS has received the forward data, while the other inputs are filled with “0” by the first zero inserter 202. For example, if there are 30 forward data resource channels from forward data resource channel #0 to forward data resource channel #29, and the forward data is transmitted to the MS over the forward data resource channel #0, and if the 0^{th} input of the 16 point DFT unit 203 has been mapped in advance to the forward data resource channel #0, the MS transmits the ACK/NACK by using only the 0^{th} DFT input, while the other inputs of the 16 point DFT unit 203 are filled with “0”. This process is controlled by the controller 210. The outputs from the 16 point DFT unit 203 are input to the sub-carrier mapper 204, and pass through sub-carrier mapping in the sub-carrier mapper 204. Specifically, the outputs of the 16 point DFT unit 203 are mapped to sub-carriers at prearranged positions from among 480 sub-carriers.

Assuming that the OFDM system takes 512 sized FFT, the second zero inserter 205 fills “0” in sub-carriers at positions other than those of the outputs from the sub-carrier mapper 204. Then, the sub-carriers are transmitted after processed by the IFFT unit 206, the P/S converter 207, and the CP adder 208 according to a common OFDM symbol configuration process.

An F-SCCH refers to a channel for transmitting control information, such as messages related to forward and reverse resource allocation and management, definition of a data packet format (Modulation and Coding Scheme; MCS), approval of an access attempt by an MS, etc., in an OFDMA mobile communication system. In order to actually transmit data, control information must be transmitted over the F-SCCH.

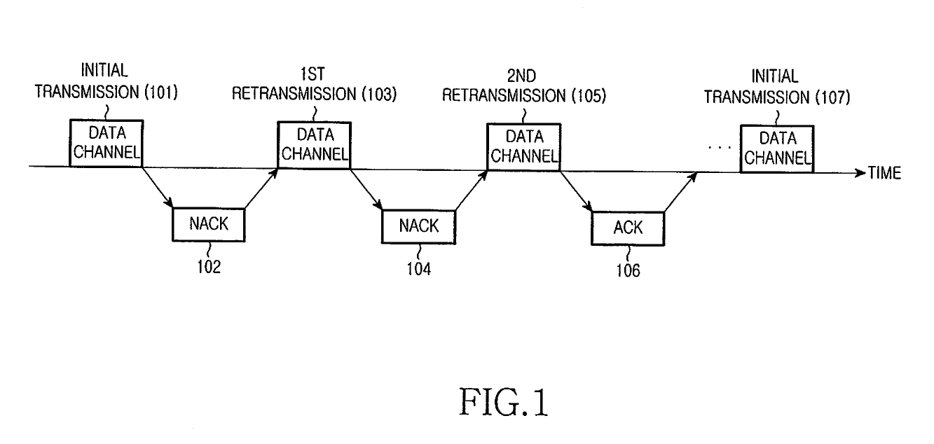

Also, as previously described in FIG. 1, a reverse-link acknowledgement channel (R-ACKCH) refers to a channel used when an MS informs a BS of a result of decoding an encoded sub-packet transmitted over a forward-link data channel (F-DCH). In other words, the MS uses the R-ACKCH when informing the BS of whether or not to succeed in packet decoding through the sub-packet received over the F-DCH.

The MS transmits an ACK to the BS when having succeeded in packet decoding through the received sub-packet, and transmits an NACK to the BS when having failed in packet decoding. Upon receiving the ACK from the MS, the BS transmits the first sub-packet of a next transmission packet to the MS. Also, upon receiving the NACK from the MS, the BS transmits the second sub-packet of the previously transmitted packet to the MS. In this way, the BS performs retransmission up to the maximum number of times supported by HARQ.

When the BS is to initially transmit a packet to the MS, it transmits control information and a sub-packet of the packet at the same time over control and data channels, and the MS attempts to decode the sub-packet received over the data channel by using the control information acquired through the control channel, such as information regarding resource allocation, etc.

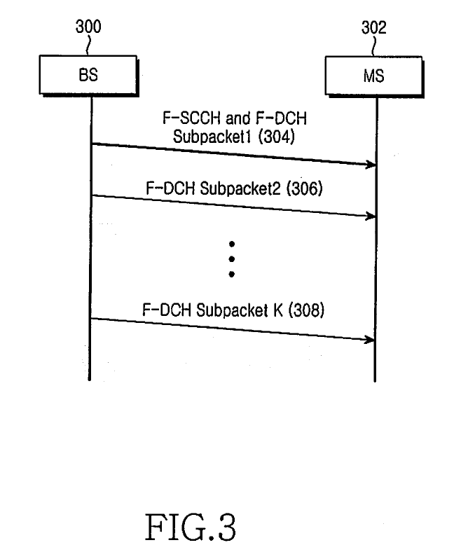

FIG. 3 illustrates signal flows of F-SCCH, F-DCH and R-ACKCH transmissions that are performed between a BS 300 and an MS 302 when the BS 300 cannot know whether or not the MS 302 successfully decodes control information transmitted over a control channel in an OFDM mobile communication system, according to an embodiment of the present invention.

Referring to FIG. 3, in step 304, the BS 300 transmits control information and sub-packet 1 to the MS 302 over the F-SCCH and the F-DCH respectively. When the MS 302 has succeeded in decoding the control information received over the F-SCCH, but still has failed in decoding the sub-packet 1 received over the F-DCH, the MS 302 transmits an NACK to the BS 300 over the R-ACKCH. Thus, the BS 300 transmits sub-packets to the MS 302 over the F-DCH within the maximum number of times of transmission supported by HARQ so that the MS 302 succeeds in decoding the data transmitted from the BS 300.

Also, when the MS 302 has failed in decoding the control information transmitted by the BS 300 over the F-SCCH, it cannot decode the sub-packet transmitted over the F-DCH. Thus, the MS 302 transmits an NACK to the BS 300, and the BS 300 reattempts data transmission up to the maximum number of times of transmission.

In other words, when the BS 300 has transmitted the control information and the sub-packet 1 over the F-SCCH and the F-DCH respectively, and the MS 302 has failed in decoding the control information transmitted over the F-SCCH, the BS cannot know whether the MS 302 has failed in decoding the control information or the packet. On account of this, the BS performs packet retransmission over the F-DCH up to the maximum number of times of transmission (k) supported by HARQ, as designated by reference numerals 306 to 308.

However, the MS 302 cannot decode the sub-packet transmitted over the F-DCH because it acquires no control information for decoding. Thus, even when the BS 300 performs packet retransmission up to the maximum number of times of transmission (k), the MS 302 will miss all the sub-packets transmitted by the BS 300.

That is, in spite of when the MS 302 cannot decode the packet due to unsuccessful decoding of the control information, the BS 300 transmits sub-packets up to the maximum number of times of transmission because it is not aware of such a situation. For example, if the maximum number of times of transmission is 6, the BS 300 allocates a resource for packet retransmission to the MS 302 five times (excluding the first initial transmission), which results in a waste of resources. In particular, this problem is more serious when a resource allocation message transmitted over the F-SCCH indicates huge resource allocation.

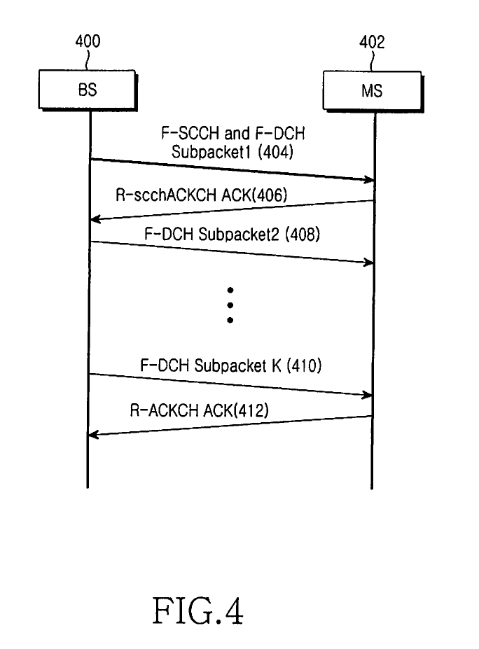

Therefore, in order to prevent a waste of resources from being caused by packet retransmission of the BS 300 when the MS 302 has failed in decoding the control information received over the F-SCCH, the MS 302 may transmit an ACK/NACK indicating a result of decoding the control information to the BS 300, so that the BS 300 can know whether or not the MS 302 has successfully decoded the control information. This is described in greater detailed below with reference to FIG. 4.

When the MS 302 transmits an ACK/NACK to the BS 300 so as to informs the BS 300 of whether or not it succeeded in decoding the control information transmitted over the F-SCCH, there is one R-scchACKCH corresponding to each F-SCCH. Also, from among R-ACKCHs, each of which carries an ACK/NACK regarding a result of decoding a sub-packet received over the F-DCH, an unused channel is used as the channel for transmitting the ACK/NACK regarding a result of decoding the control information received over the F-SCCH.

According to the signal flows in the conventional OFDMA mobile communication system, when the BS 300 receives an ACK in response to decoding of the control information from the MS 302 after transmitting the control information and the sub-packet over the F-SCCH and the F-DCH respectively, it transmits a new packet if receiving an ACK for the sub-packet from the MS 302. However, if the BS 300 receives an NACK for the sub-packet from the MS 302, it performs retransmission five times (because the maximum number of times of transmission is 6) in such a manner as to transmit the second to sixth sub-packets of the current packet until the MS 302 succeeds in packet decoding.

With regard to this, when the MS 302 transmits an NACK to the BS 300 over the R-scchACKCH, and transmits an NACK to the BS 300 over the R-ACKCH because it has failed in decoding the sub-packet received over the F-DCH, the BS 300 may retransmit the same control information as the previously transmitted control information and the first sub-packet to the MS 302, or may terminate transmission of the corresponding data and transmit new control information to the MS 302 over the F-SCCH.

FIG. 4 illustrates signal flows of F-SCCH, F-DCH, R-scchACKCH and R-ACKCH transmissions that are performed between a BS 400 and an MS 402 when the MS 402 fails in decoding a first sub-packet and the BS 400 can know whether or not the BS 402 successfully decodes control information in an OFDM mobile communication system, according to an embodiment of the present invention.

In step 404, the BS 400 transmits control information and sub-packet 1 to the MS 402 over the F-SCCH and the F-DCH respectively. In step 406, when the MS 402 has succeeded in decoding the control information and has failed in decoding the sub-packet 1, it transmits an ACK to the BS 400 over the R-scchACKCH because the control information has been successfully decoded. Upon receiving the ACK in step 406, the BS 400 becomes aware of successful decoding of the control information, and transmits the second sub-packet (i.e., sub-pack 2) to the MS 402 at next transmission 408. In step 410, the BS 400 transmits sub-packets up to the maximum number of times of transmission (k) minus 1. Also, in step 412, when the MS 402 has succeeded in decoding the kth transmitted sub-packet, it transmits an ACK to the BS 400 over the R-ACKCH.

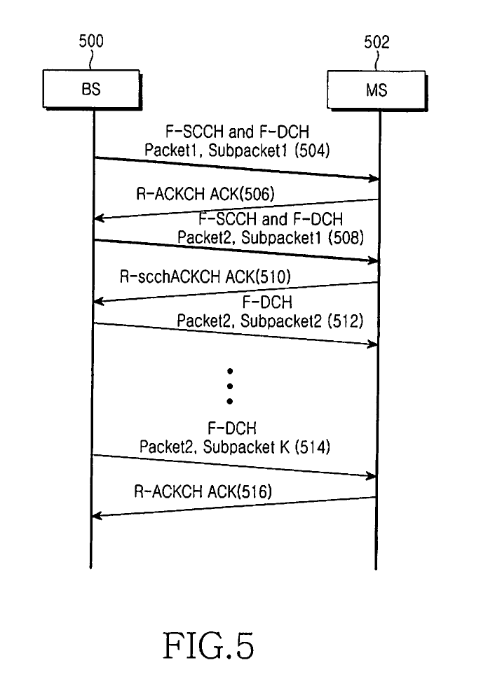

FIG. 5 illustrates signal flows of F-SCCH, F-DCH, R-scchACKCH and R-ACKCH transmissions that are performed between a BS 500 and an MS 502 when the MS 502 succeeds in decoding a first sub-packet and the BS 500 can know whether or not the MS 502 successfully decodes control information in an OFDM mobile communication system, according to an embodiment of present invention.

As used herein, the term “sub-packet” is considered a segmented packet, and Packet 1, Sub-packet 1 in FIG. 5 indicates that the first sub-packet of Packet 1 is transmitted. Packet 1 and Packet 2 denote different packets. In step 504, the BS 500 transmits control information and the Packet 1, Sub-packet 1 (i.e., Sub-packet 1 of Packet 1) to the MS 502 over the F-SCCH and the F-DCH respectively. In step 506, when the MS 502 has succeeded in decoding the first sub-packet (i.e., Sub-packet 1), it transmits an ACK to the BS 500 over the R-ACKCH, which means that the MS 502 has also succeeded in decoding the control information received over the F-SCCH. Upon receiving the ACK from the MS 502 in step 506, the BS 500 transmits new control information necessary for receiving a new packet (i.e., Packet 2) by the MS 502, and the first sub-packet of the new packet (i.e., Packet 2, Sub-packet 1), to be received using the new control information, to the MS 502 over the F-SCCH and the F-DCH respectively in step 508.

In step 510, when the MS 502 has failed in decoding the first sub-packet (Sub-packet 1) of the second packet (Packet 2), it transmits an ACK to the BS 500 over the R-scchACKCH, as in step 406 of FIG. 4, so that the BS 500 transmits the second sub-packet (Sub-packet 2) of the second packet (Packet 2) at next transmission.

Upon receiving the ACK over the R-scchACKCH in step 510, the BS 500 transmits sub-packet up to the maximum number of times of transmission (k) minus 1 in steps 512 to 514. Also, in step 516, when the MS 502 has succeeded in decoding the kth transmitted sub-packet, it transmits an ACK to the BS 500 over the R-ACKCH.

In the mobile communication system to which the embodiments of the present invention are applied, a waste of resources may be prevented by the fact that the MS informs the BS of whether or not it succeeded in decoding control information, as illustrated in FIGS. 4 and 5, but the probability that the MS fails in decoding the control information may be only about 1%.

In other words, since the probability that the MS successfully decodes control information transmitted over the F-SCCH is 99%, it transmits an ACK to the BS over the R-scchACKCH with a probability of 99% because the farther the MS is from the BS (in particular, when the MS is located at a cell boundary), the more difficult it is to succeed in decoding the first sub-packet. Even if the probability that the MS successfully decodes control information transmitted over the F-SCCH is somewhat lowered in order to reduce high power used for transmitting data to the MS located at a cell boundary (e.g., when the MS fails in F-SCCH decoding with a probability of 10 to 20%), the probability that the MS succeeds in decoding the first sub-packet is still lower than the lowered decoding success rate for the control information. On account of this, the problem that the MS frequently transmits an ACK/NACK over the R-scchACKCH cannot be solved.

Therefore, in an OFDMA mobile communication system according to an embodiment of the present invention, as will be described below, frequent transmission of an ACK/NACK over the R-scchACKCH is prevented by adjusting when an MS transmits an ACK/NACK regarding successful decoding of control information after having received the control signal and a sub-packet from a BS over the F-SCCH and the F-DCH respectively.

The embodiment of the present invention, as will be described below, intends to reduce the number of ACK/NACK transmissions over the R-scchACKCH and thus reduce system load by adjusting a time point of ACK/NACK transmission over the R-scchACKCH when an MS transmits an ACK/NACK to a BS over the R-scchACKCH so as to inform the BS of whether or not to succeed in decoding control channel received over the F-SCCH in an OFDMA mobile communication system.

If a time point of ACK/NACK transmission over the R-scchACKCH is too early, the number of times of ACK/NACK transmission increases, which causes an increase in system load. Contrarily, if a time point of ACK/NACK transmission over the R-scchACKCH is too late, ACK/NACK transmission becomes useless.

Accordingly, in the embodiment of the present invention, a time point of ACK/NACK transmission over the R-scchACKCH is adjusted considering the amount of reverse data to be transmitted by an MS, the geometry of an MS, or the like.

According to the embodiment of the present invention, a time point of ACK/NACK may be adjusted and determined by:

1) BS determines time point of R-scchACKCH transmission of each MS, m, by upper layer signaling (L3 signaling).

2) Time point of R-scchACKCH transmission is determined according to control channels.

It is assumed that there are five control channels, that is, F-SCCH 0, F-SCCH 1, F-SCCH 2, F-SCCH 3, and F-SCCH 4, which are used for transmitting control information from a BS to MSs (the number of F-SCCHs is variable). For example, suppose that the BS and the MSs have promised not to transmit an ACK/NACK for control information transmitted over the F-SCCH 0 and the F-SCCH 1, to transmit an ACK/NACK for control information transmitted over the F-SCCH 2 when the first sub-packet is received (m=1), to transmit an ACK/NACK for control information transmitted over the F-SCCH 3 when the second sub-packet is received (m=2), and to transmit an ACK/NACK for control information transmitted over the F-SCCH 4 when the third sub-packet is received (m=3).

Then, upon receiving control information over the F-SCCH 0 and the F-SCCH 1 respectively, the MSs do not transmit an ACK/NACK regarding a result of decoding the control information over R-scchACKCH. For the F-SCCH 2, 3 or 4, the MSs transmit an ACK/NACK regarding a result of decoding control information over R-scchACKCH 2, 3 or 4 at the time point when the first, second or third sub-packets are received (M=1, 2 or 3).

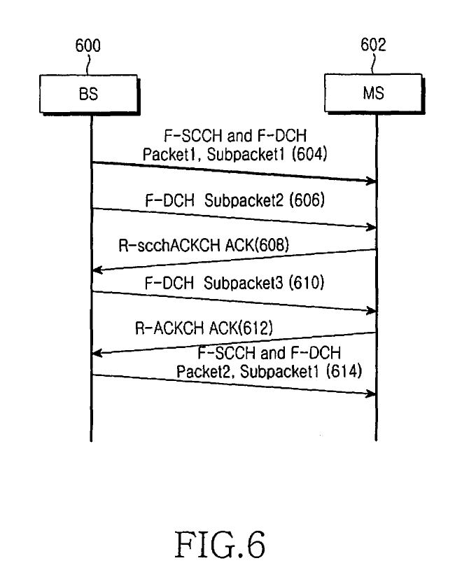

FIG. 6 illustrates signal flows of F-SCCH, F-DCH, R-scchACKCH and R-ACKCH transmissions that are performed between a BS 600 and an MS 602, based on a method of determining a time point of ACK/NACK transmission over the R-scchACKCH when the BS 600 can know whether or not the MS 602 successfully decodes control information in an OFDM mobile communication system, according to an embodiment of the present invention.

By way of example, it is assumed in FIG. 6 that a result of decoding control information is transmitted over the R-scchACKCH at the time point when the second sub-packet (Sub-packet 2) is received (in the case of m=2).

The reason why m=2 is assumed in FIG. 6 is that it is difficult to succeed in decoding the first sub-packet, as described above. Thus, the MS 602 transmits a result of decoding control information over the R-scchACKCH after having received the second sub-packet. Consequently, in this embodiment, the MS is prevented from frequently transmitting a result of decoding control information over the R-scchACKCH.

In step 604 of FIG. 6, the BS 600 transmits control information and the first sub-packet of Packet 1 (Packet 1, Sub-packet 1) to the MS 602 over the F-SCCH and the F-DCH, respectively. In step 606, since there is no ACK/NACK from the MS 602, the BS 600 transmits the second sub-packet of the Packet 1 (Packet 1, Sub-packet 2).

Subsequently, since the MS 602 has prearranged with the BS 600 to transmit a result of control information decoding to the BS 600 over the R-scchACKCH if packet decoding after the reception of the second sub-packet is not successful, in step 608, it transmits an ACK to the BS 600 over the R-scchACKCH when having successfully decode the control information.

That is, if the MS 602 has succeeded in packet decoding after the reception of the second sub-packet, it doesn't need to transmit an ACK/NACK over the R-scchACKCH in step 608 because it transmits an ACK to the BS 600 over the R-ACKCH. However, if the MS 602 has not succeeded in packet decoding even after the reception of the second sub-packet, it transmits a result of control information decoding to the BS 600 over the R-scchACKCH in step 608. In this way, the number of times of transmitting a result of control information decoding over the R-scchACKCH can be reduced.

Upon receiving the ACK over the R-scchACKCH in step 608, the BS 600 transmits the third sub-packet (Sub-packet 3) to the MS 602 over the F-DCH in step 610 because it has not yet received an ACK over the R-ACKCH indicating successful data decoding from the MS 602. Contrarily, when the BS 600 receives an NACK from the MS 602 over the R-scchACKCH in step 608, it will retransmit the control information to the MS 602 over the F-SCCH. Upon receiving the Sub-packet 3 in step 610, the MS 602 transmits an ACK to the BS 600 over the R-ACKCH in step 612 when having succeeded in packet decoding through the received Sub-packet 3. Upon receiving the ACK in step 612, the BS 600 becomes aware that the MS 602 has successfully received the Packet 1, and in step 614, transmits the first sub-packet of a new packet (i.e., Packet 2, Sub-packet 1) and control information necessary for receiving the new packet (Packet 2) to the MS 602 over the F-DCH and the F-SCCH respectively.

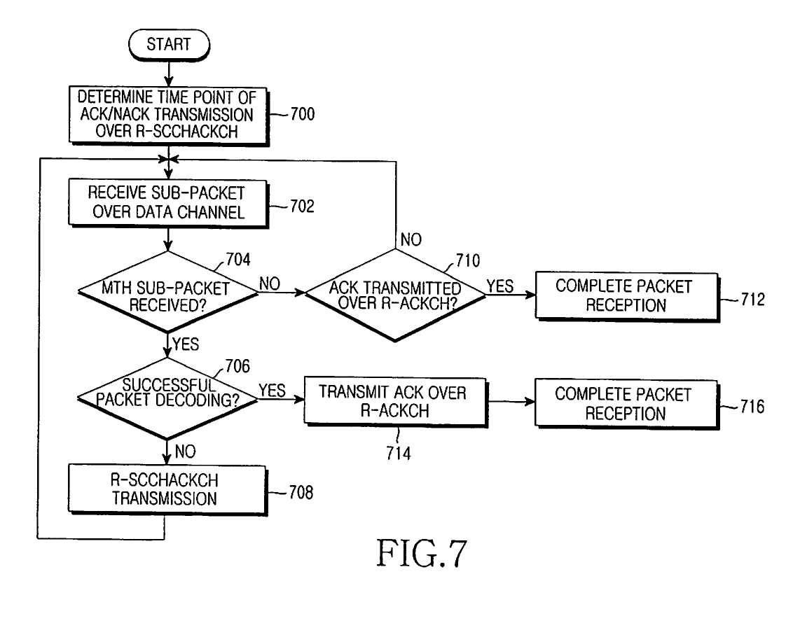

FIG. 7 illustrates the operation of the MS 602 for transmitting an ACK/NACK over the R-scchACKCH according to an embodiment of the present invention.

In step 700, a time point of ACK/NACK transmission over the R-scchACKCH is determined for each MS through the adjustment method thereof, as described above. In step 700, the time point when the MS transmits an ACK/NACK over the R-scchACKCH may be available to the MS through upper layer signaling (L3 signaling) from the BS 600, or may be determined by negotiation between the MS and a BS. Also, when one or more F-SCCHs are defined, a time point of ACK/NACK transmission may be determined according to the respective F-SCCHs.

In step 702, when a sub-packet is received over a data channel, that is, the F-DCH, from the BS 600, the MS proceeds to step 704, and checks if the sub-packet received over the data channel is the mth sub-packet. As used herein and described above, “m” is the index of a sub-packet corresponding to the time point when the MS transmits an ACK/NACK regarding a result of decoding control information over the R-scchACKCH. In FIG. 6, m is set to 2.

When a result of the check in step 704 shows that the received sub-packet is the mth sub-packet, the MS checks in step 706 if it has succeeded in packet decoding through the sub-packet received from the BS. If the MS has not successfully decoded the packet through the received sub-packet, in step 708, it transmits an ACK or NACK to the BS over the R-scchACKCH according to whether or not it has succeeded in decoding control information.

Contrarily, when a result of the check in step 704 shows that the received sub-packet is not the mth sub-packet, the MS proceeds to step 710, and transmits an ACK or NACK to the BS over the R-ACKCH according to whether or not it has succeeded in packet decoding through the received sub-packet. If the MS has succeeded in packet decoding and thus has transmitted an ACK to the BS over the R-ACKCH, it proceeds to step 712, and completes the packet reception. However, if the MS has failed in packet decoding, it returns to step 702, and receives a sub-packet transmitted from the BS over the data channel. When the MS and the BS use a scheme in which an ACK is matched to “on”, and an NACK is matched to “off”, NACK transmission has the meaning of “off”, that is, there is no transmission. Also, when a result of the check in step 706 shows that the MS has successfully decoded the packet, the MS proceeds to step 714, and completes the packet reception in step 716.

The MS according to the embodiment of the present invention transmits an ACK to the BS over the R-ACKCH and completes the reception of a corresponding packet when the index of a received sub-packet is “m” and decoding of the sub-packet is successful, or transmits a result of control information decoding to the BS over the R-scchACKCH and receives a next sub-packet when decoding of the sub-packet is not successful.

Also, when the index of the received sub-packet is not “m” and packet decoding is not successful, the MS transmits an NACK over the R-ACKCH, as in a common HARQ operation, thereby receiving sub-packets of the same packet within the maximum number of times of transmission.

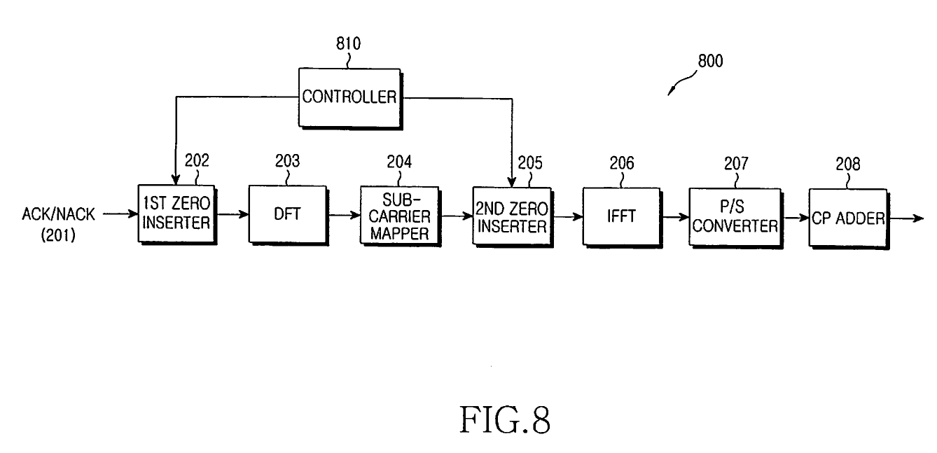

FIG. 8 illustrates the structure of an MS transmitter 800 according to an embodiment of the present invention.

In the transmitter according to this embodiment, similar components to those of the transmitter in FIG. 2 are designated by similar reference numerals.

In FIG. 8, the operation of a controller 810 is different from that of the controller 210 in FIG. 2. In the following description, blocks designated by reference numerals 202 to 208 in FIG. 8 will be referred to as a transmitter module for the convenience of explanation.

The controller 810 according to this embodiment controls the transmitter to transmit an ACK/NACK regarding a result of decoding control information received over a control channel to a BS over the R-scchACKCH after having received the mth sub-packet prearranged between the MS and the BS.

The above-mentioned embodiment of the present invention makes it possible to reduce the number of times of ACK/NACK transmission over the R-scchACKCH and thus support an efficient HARQ operation by controlling the MS transmitter to transmit an ACK/NACK regarding a result of decoding control information received over a control channel to a BS over the R-scchACKCH after having received the mth sub-packet according to the time point predetermined by the adjustment method thereof. That is, according to the aforementioned embodiment, after a packet is received from a BS in an HARQ scheme over a forward data channel, and control information for decoding the packet is received from the BS over a forward control channel, the controller 810 stands by without transmitting an ACK/NACK for the control information, and then determines to transmit an ACK/NACK for the control information when the mth sub-packet corresponding to each retransmission of the packet is received. Also, the transmitter module transmits the ACK/NACK for the control information to the BS over a R-scchACKCH at the time point determined by the controller 810.

According to the present invention as described above, a time point when an ACK/NACK regarding a result of control information decoding is transmitted over the R-scchACKCH is adjusted to a predetermined transmission point, so that it is possible to efficiently support an HARQ operation.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of transmitting a reverse Acknowledgement/Non-Acknowledgement (ACK/NACK) for a forward control channel in a mobile communication system supporting Hybrid Automatic Repeat reQuest (HARQ), the method comprising the steps of:
receiving control information for decoding a packet from a base station over the forward control channel, and receiving the packet from the base station in an HARQ scheme over a forward data channel; and
transmitting an ACK/NACK for the control information to the base station over a first reverse ACK channel, when an mth sub packet corresponding to each retransmission of the packet is received from the base station, wherein m is a predetermined integer greater than or equal to two.

2. The method as claimed in claim 1, wherein the ACK/NACK for the control information is transmitted when the packet is not successfully decoded after the mth sub-packet is received.

3. The method as claimed in claim 1, further comprising transmitting an ACK for the packet to the base station over a second reverse ACK channel when the packet is successfully decoded before the mth sub-packet is received.

4. The method as claimed in claim 1, wherein m is acquired through signaling from the base station.

5. The method as claimed in claim 1, wherein when there are one or more forward control channels, m is predefined for the respective forward control channels.

6. A mobile station apparatus for transmitting a reverse Acknowledgement/Non-Acknowledgement (ACK/NACK) for control information in a mobile communication system supporting Hybrid Automatic Repeat reQuest (HARQ), the apparatus comprising:
a control unit for determining whether to transmit the ACK/NACK for the control information when the control information for decoding a packet is received from a base station over a forward control channel, wherein the packet is received from the base station in an HARQ scheme over a forward data channel, and an mth sub-packet corresponding to each retransmission of the packet is received from the base station; and
a transmitter module for transmitting the ACK/NACK for the control information to the base station over a first reverse ACK channel at a time point determined by the control unit.

7. The mobile station apparatus as claimed in claim 6, wherein the control unit controls the transmitter module to transmit the ACK/NACK for the control information to the base station when the packet is not successfully decoded after the mth sub-packet is received.

8. The mobile station apparatus as claimed in claim 6, wherein the control unit controls the transmitter unit to transmit an ACK for the packet to the base station over a second reverse ACK channel when the packet is successfully decoded before the mth sub-packet is received.

9. The mobile station apparatus as claimed in claim 6, wherein m is acquired through signaling from the base station.

10. The mobile station apparatus as claimed in claim 6, wherein when there are one or more forward control channels, the m is predefined for the respective forward control channels.
